(19) United States
(12) Patent Application Publication
(10) Pub. No.: US 2024/0248817 A1
(43) Pub. Date: Jul. 25, 2024

(54) METHOD, DEVICE, AND COMPUTER PROGRAM PRODUCT FOR DATA RECOVERY

(71) Applicant: Dell Products L.P., Round Rock, TX (US)

(72) Inventors: Qiaosheng Zhou, Beijing (CN); Chen Gong, Beijing (CN); Huan Chen, Beijing (CN); Jian Liu, Beijing (CN)

(21) Appl. No.: 18/238,192

(22) Filed: Aug. 25, 2023

(30) Foreign Application Priority Data
Jan. 19, 2023 (CN) 202310080342.8

(51) Int. Cl. G06F 11/14

(52) U.S. Cl. CPC G06F 11/1469; G06F 2201/84

(57) ABSTRACT

Techniques for data recovery involve determining, based on a relationship between a missing inode in an inode table and a data logical address in an extension table, whether the inode is a target inode that is able to be recovered. The techniques further involve acquiring, in response to a determination that the inode is the target inode, associated data corresponding to the target inode. The techniques further involve recovering the inode based on the acquired associated data. Accordingly, volume-level data loss can be avoided, a data loss rate of a storage product can be reduced, and user satisfaction can be enhanced.

### CROSS-REFERENCE TO RELATED APPLICATION

This application claims priority to Chinese Patent Application No. CN202310080342.8, on file at the China National Intellectual Property Administration (CNIPA), having a filing date of Jan. 19, 2023, and having “METHOD, DEVICE AND COMPUTER PROGRAM PRODUCT FOR DATA RECOVERY” as a title, the contents and teachings of which are herein incorporated by reference in their entirety.

### TECHNICAL FIELD

Embodiments of the present disclosure generally relate to the field of data storage, and more particularly, to a method, an electronic device, and a computer program product for data recovery.

### BACKGROUND

A computing system acquires a high degree of functionality by executing software programs. The computing system uses a storage device to store such software programs and other files. A lower part of the file system involves where to place a data block in the storage device. The file system itself does not have visibility to the storage device, but views the storage as a volume. The file system may build directories in the volume and save files to a namespace at the root of the namespace or in a directory of the namespace. Generally, metadata and data extension such as an inode may be set in the namespace, and a mapping layer may be created to realize read or write paths to the storage device. However, data loss is still an urgent problem for a storage product.

### SUMMARY OF THE INVENTION

Embodiments of the present disclosure provide a method, a device, and a computer program product for data recovery.

In a first aspect of the present disclosure, a method for data recovery is provided. The method includes: determining, based on a relationship between a missing inode in an inode table and a data address in an extension table, whether the inode is a target inode that is able to be recovered; acquiring, in response to a determination that the inode is the target inode, associated data corresponding to the target inode; and recovering the inode based on the acquired associated data.

In a second aspect of the present disclosure, an electronic device is provided. The electronic device includes at least one processing unit and at least one memory. The at least one memory is coupled to the at least one processing unit and stores instructions for execution by the at least one processing unit. The instructions, when executed by the at least one processing unit, cause the electronic device to perform actions including: determining, based on a relationship between a missing inode in an inode table and a data address in an extension table, whether the inode is a target inode that is able to be recovered; acquiring, in response to a determination that the inode is the target inode, associated data corresponding to the target inode; and recovering the inode based on the acquired associated data.

In a third aspect of the present disclosure, a computer program product is provided. The computer program product is tangibly stored in a non-transitory computer storage medium and includes machine-executable instructions. The machine-executable instructions, when executed by a device, cause the device to perform any step of the method according to the first aspect of the present disclosure.

The Summary of the Invention part is provided to introduce the selection of concepts in a simplified form, which will be further described in the Detailed Description below. The Summary of the Invention part is neither intended to identify key features or essential features of the present disclosure, nor intended to limit the scope of the present disclosure.

### BRIEF DESCRIPTION OF THE DRAWINGS

The above and other objectives, features, and advantages of the present disclosure will become more apparent by describing example embodiments of the present disclosure in further detail with reference to the accompanying drawings, and in the example embodiments of the present disclosure, the same reference numerals generally represent the same components.

FIG. 1A shows a schematic diagram of an example environment in which some embodiments of the present disclosure can be implemented;

FIG. 1B shows a schematic diagram of a namespace layer according to some embodiments of the present disclosure;

FIG. 1C shows a schematic diagram of a mapping layer according to some embodiments of the present disclosure;

FIG. 2 shows a schematic diagram of an example method for data recovery according to some embodiments of the present disclosure;

FIG. 3A shows an example of an inode according to some embodiments of the present disclosure;

FIG. 3B is a schematic flow chart of reconstructing a missing inode according to some embodiments of the present disclosure; and

FIG. 4 shows a schematic block diagram of an example device that may be used for implementing embodiments of the present disclosure.

In the accompanying drawings, identical or corresponding numerals represent identical or corresponding parts.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

Preferred embodiments of the present disclosure will be described in more detail below with reference to the accompanying drawings. Although preferred embodiments of the present disclosure are illustrated in the accompanying drawings, it should be understood that the present disclosure may be implemented in various forms and should not be limited by the embodiments illustrated herein. Rather, these embodiments are provided to make the present disclosure more thorough and complete and to fully convey the scope of the present disclosure to those skilled in the art.

The term “include” and variants thereof used in this text indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects. Other explicit and implicit definitions may also be included below.

As mentioned above, data loss is still an urgent problem for a storage product. For example, due to cache loss, code defects, and other reasons, part of metadata of a path used for reading or writing data (such as part of inodes in an inode table) may be lost. In this case, read from/write to a storage device may fail due to a “media error.”

In a conventional solution, if it is found that some metadata is missing (for example, some inodes are missing in the inode table), resulting in interruption of the data read or write path, for a missing inode, other data associated with the inode (for example, a data logical address in data extension) is deleted to avoid the read/write failure. In this way, if the inode is lost, a volume will also disappear along with the deletion of data, which is not expected by a user.

A solution for data recovery is proposed in the embodiments of the present disclosure to solve the above problem and one or more of other potential problems. In this solution, for an inode that is missing and can be recovered, associated data corresponding to the inode is acquired. Then, the inode is recovered based on the acquired associated data. In this way, the lost metadata can be recovered to keep data on disks consistent, so that a data read/write path can be recovered, and the loss of volume-level data can be avoided.

The embodiments of the present disclosure will be described in detail below with reference to the accompanying drawings.

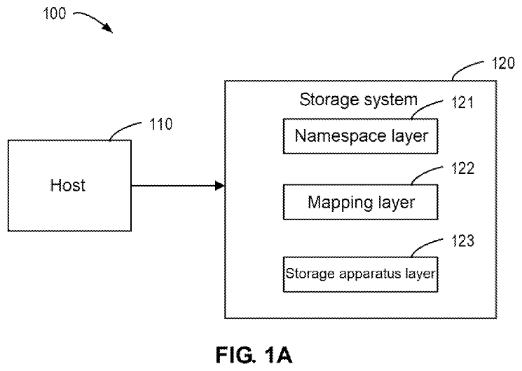

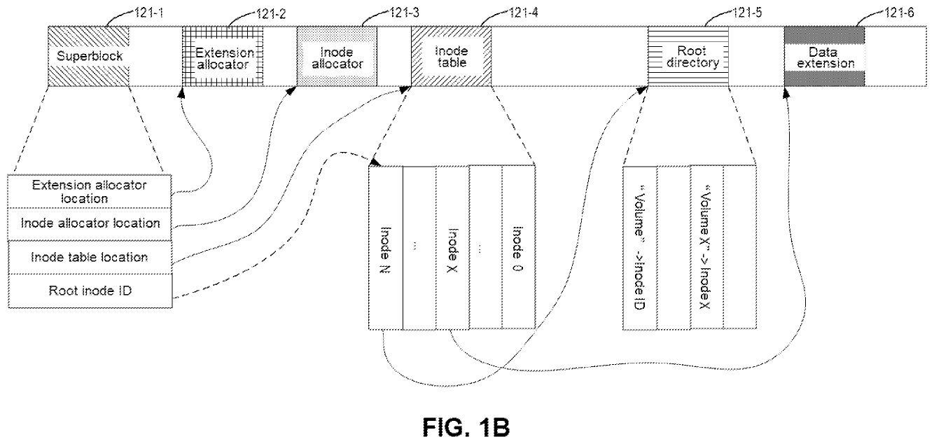

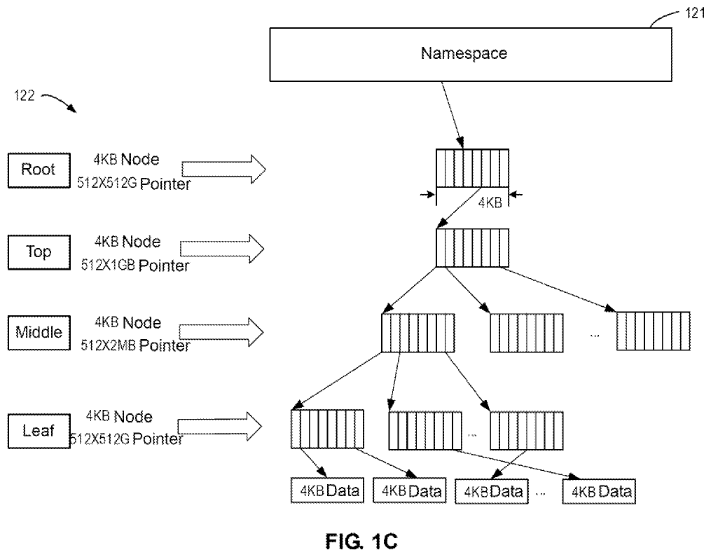

FIG. 1A shows a schematic diagram of example environment 100 in which the embodiments of the present disclosure can be implemented. Example environment 100 is used for implementing operations related to data read/write, including metadata recovery in a case of data read/write failure mentioned above, data read/write completion using the recovered path, and the like. It should be understood that the system shown in FIG. 1A is only an example.

As shown in FIG. 1A, example environment 100 includes host 110 and storage system 120. In an embodiment, host 110 may communicate with storage system 120 via a communication channel and communication interface having a predetermined protocol. Host 110 may be a computer having one or more central processing units (CPUs), for sending instructions for implementing the method of the present invention to a computer peripheral (such as storage system 120). The computer peripheral (such as storage system 120) may be attached to host 110 via, for example, a computer bus interconnection (such as a peripheral component interconnect (PCI), a PCI extension (PCI-X), and a PCIExpress (PCIe)), a communication part, and/or a computer network. In another embodiment, storage system 120 may be integrated into host 110.

Storage system 120 includes namespace layer 121, mapping layer 122, and storage apparatus layer 123. Storage system 120 is configured to operate according to instructions received from host 110 to implement the solution for realizing data recovery in the present invention. Namespace layer 121 is a logical storage segment addressable by host 110. Subspaces in namespace layer 121 may be mapped, through mapping layer 122, to data blocks addressable by storage apparatus layer 123.

A schematic architecture of namespace layer 121 is shown in FIG. 1B. As shown in FIG. 1B, namespace layer 121 includes superblock 121-1, extension allocator 121-2, inode allocator 121-3, inode table 121-4, root directory 121-5, and data extension 121-6. For example, inode table 121-4 (having an offset of 64 G and a length of 64 G) may include 160000000 inodes. Each inode may represent a directory or file with aligned data extension of 512 G.

Mapping layer 122 is used for mapping a logical space to a virtual space, and one of its important metadata may be shown in FIG. 1C. Each node in FIG. 1C contains 512 pointers. If a failure is found during the mapping layer recovery, the corresponding pointer may be marked (for example, using a “U” flag). For those logical spaces, data reading may fail, and a “media error” may occur, but data writing may be successfully rewritten. In addition, a back point in FIG. 1C may include the following information:

| Field | Description |
|---|---|
| mNsAddr | Namespace Address |
| mExtentOffset | Extension offset within a volume |
| mInum | NS inode number |
| mVolumeId | Volume ID |
| mContainerId | Storage container ID |
| mSnapGroupId | Tenant ID |
| mTenantId | Namespace inode instance ID |
| mInstanceId | Namespace extension type |

An extension allocator location section in superblock 121-1 is associated with extension allocator 121-2. An inode allocator location section in superblock 121-1 is associated with inode allocator 121-3. An inode table location section in superblock 121-1 is associated with inode table 121-4. A root inode Identity (ID) in superblock 121-1 is associated with an inode in inode table 121-4. Each inode in inode table 121-4 may be associated with a corresponding volume in the root directory (or a snapshot of the volume, a clone of the volume) and a corresponding data logical address in the data extension. In one example, a volume may be an internal volume, such as a control path database. In another example, a volume may be a user volume, which is created by a user to store data.

Storage system 120 may include a volatile or non-volatile memory apparatus. For example, a plurality of non-volatile memory devices (NVMs) may include at least one of the following storage devices: a static random access memory (SRAM), a dynamic RAM (DRAM), a synchronous DRAM (SDRAM), a read-only memory (ROM), a programmable ROM (PROM), an electrically programmable ROM (EPROM), an electrically erasable programmable ROM (EEPROM), a flash memory device, a phase-change RAM (PRAM), a magnetic RAM (MRAM), a resistive RAM (RRAM), and a ferroelectric RAM (FRAM).

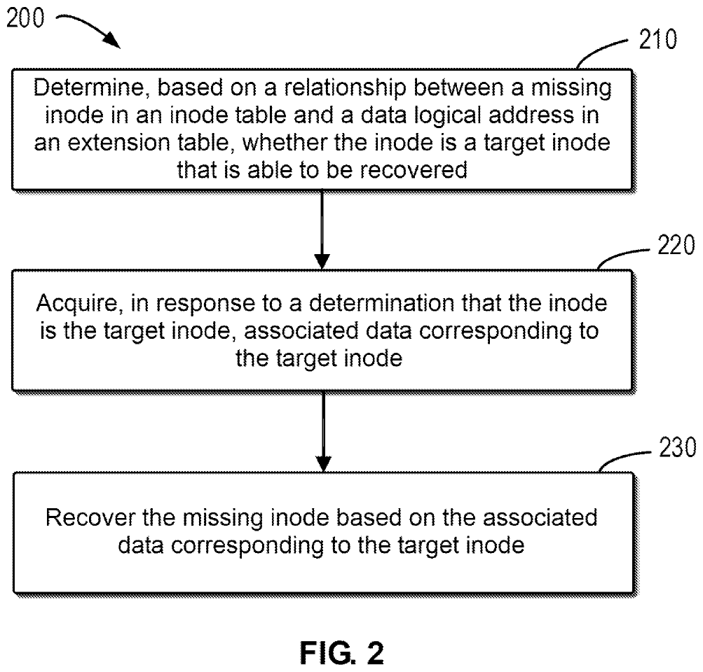

FIG. 2 shows a flow chart of example method 200 for data recovery according to some embodiments of the present disclosure. Method 200 may be performed, for example, in example environment 100 as shown in FIG. 1. For example, method 200 may be implemented by storage system 120 according to instructions generated by host 110. Method 300 may include additional actions not shown and/or may omit actions shown, and the scope of the present disclosure is not limited in this regard. Method 200 is described in detail below with reference to FIG. 1A and FIG. 1B.

As shown in FIG. 2, at block 210, based on a relationship between a missing inode in an inode table (for example, inode table 121-4) and a data logical address in an extension table (or a data logical address in data extension 121-6), it is determined whether the inode is a target inode that is able to be recovered. The extension table may be used for describing a mapping relationship between an inode pointer in a namespace and a data logical address. The extension table may be an output recovered by mapping layer 122, as shown in Table 1.

TABLE 1
Extension Table

| Inode | | Example | Volume | Snapshot | | |
|---|---|---|---|---|---|---|
| Number | Type | ID | ID | group ID | Offset | Length |
| 0 | Directory | 0 | 0 | 0 | 0x8000000000 | 0x8000000000 |
| 1 | Directory | 0 | 0 | 0 | 0x10000000000 | 0x8000000000 |
| 2 | Directory | 0 | 0 | 0 | 0x18000000000 | 0x8000000000 |
| . . . | . . . | . . . | . . . | . . . | . . . | . . . |
| 17 | File | 0 | 0xa | 0x5 | 0x2008000000000 | 0x8000000000 |
| 1844674 | Namespace | 0 | 0 | 0 | 0x0 | 0x8000000000 |
| 4073709 | metadata | | | | | |
| 551615 | | | | | | |

In some embodiments, a step shown at block 210 may be implemented in the following manner.

First, the inode in the inode table is validated to determine whether the inode is a failed inode. For example, if no corresponding data block can be found by using the inode or the found data block is invalid, the inode may be determined as a failed inode; otherwise, it is not a failed inode. Next, by validating an inode allocator (for example, inode allocator 121-3), a missing inode corresponding to the failed inode is determined from an inode set indicated by the inode allocator. The step may also be explained mathematically as follows.

An inode set (I_{failed}) is created in the inode table validation and recovery process. The failed inode set (I_{failed}) includes failed inodes failed in namespace read. If some inodes are lost, the failure should be reported in the validation process of the inode allocator. It should be understood that under normal circumstances, if the inode allocator is validated successfully, an inode set (I_{allocated}) allocated by the inode allocator may be obtained. When some inodes are not allocated normally, the above failure of missing inodes will occur. According to the two sets, I_{failed} and I_{allocated}, an inode set (Iₗₒₛₜ) composed of the above missing inodes may be obtained, which may be expressed by the following equation (1):

$${I}_{lost} = {I}_{failed} ⋂ {I}_{allocated} \qquad Equation ( 1 )$$

Next, the missing inodes and the extension table are used to determine whether the failed inode is a target inode. For example, by validating the extension allocator, it is determined whether the inodes in the inode table (for example, inode table 121-4) are consistent with the information about reading/writing data in the data extension (for example, data extension 121-6). If inconsistent, it indicates that there is a missing inode in the inode table or an orphan extension in the data extension (that is, the missing inode can be correctly mapped to the extension of a valid data block under normal conditions). In addition, by validating the mapping layer extension, it may be determined whether there is a matching orphan extension for the missing inode according to the extension table output from the mapping layer, so as to determine whether the failed inode is the target inode.

In some embodiments, the determination step may be realized using the above extension table. Specifically, for a missing inode (for example, an inode in inode set Iₗₒₛₜ), it is determined whether there is an associated data logical address in the extension table. For example, if the inode with a number 17 is missing, it is determined whether data logical addresses (such as 0x2008000000000 and 0x8000000000) associated with the inode 17 exist. If an associated data logical address exists in the extension table, the failed inode (or missing inode) is determined as the target inode that is able to be recovered. For example, if it is determined that the data logical addresses associated with inode 17 (such as 0x2008000000000 and 0x8000000000) exist, inode 17 is determined as the target inode to realize subsequent recovery. Similarly, the step may also be explained mathematically as follows.

According to the numbered inodes in Table 1, an inode set Iₘₐₚₚₑᵣ may be obtained, and the inode set Iₘₐₚₚₑᵣ indicates all inodes reported by the mapping layer recovery. Then, an inode set I_{recovery} that needs to be recovered is determined from the inode set Iₘₐₚₚₑᵣ. The inode set I_{recovery} consists of one or more of the above target inodes. Details may be expressed by the following equation (2):

$${I}_{recovery} = {I}_{lost} ⋂ {I}_{mapper} \qquad Equation ( 2 )$$

The step shown at block 210 may be used above for determining the inode that needs to be recovered. The steps shown at block 220 and block 230 may be used below for recovering the inode.

At block 220, in response to a determination that the inode is the target inode, associated data corresponding to the target inode is acquired. In some embodiments, at least some associated data in the associated data corresponding to the target inode may be acquired through extension in the mapping layer. For example, information contained in the back point above may be used for acquiring at least one of the following: an object type, a snapshot group identity (ID), a volume ID, an inode ID, an object instance ID, or data extension information.

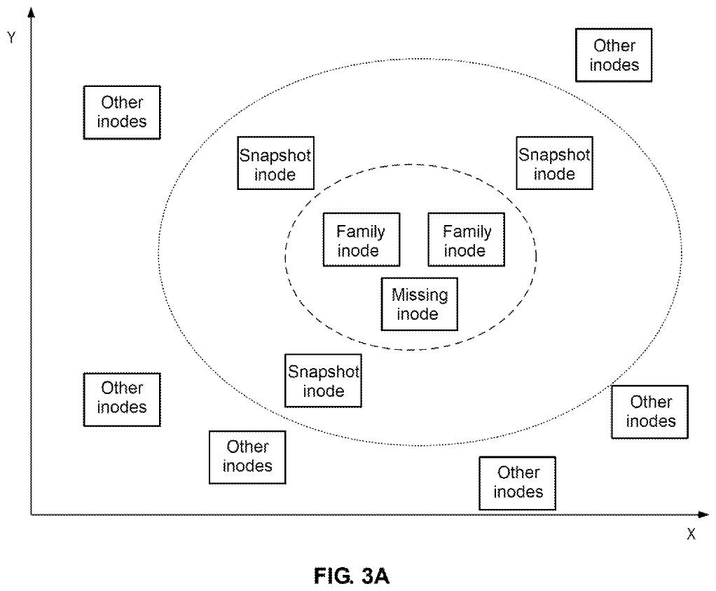

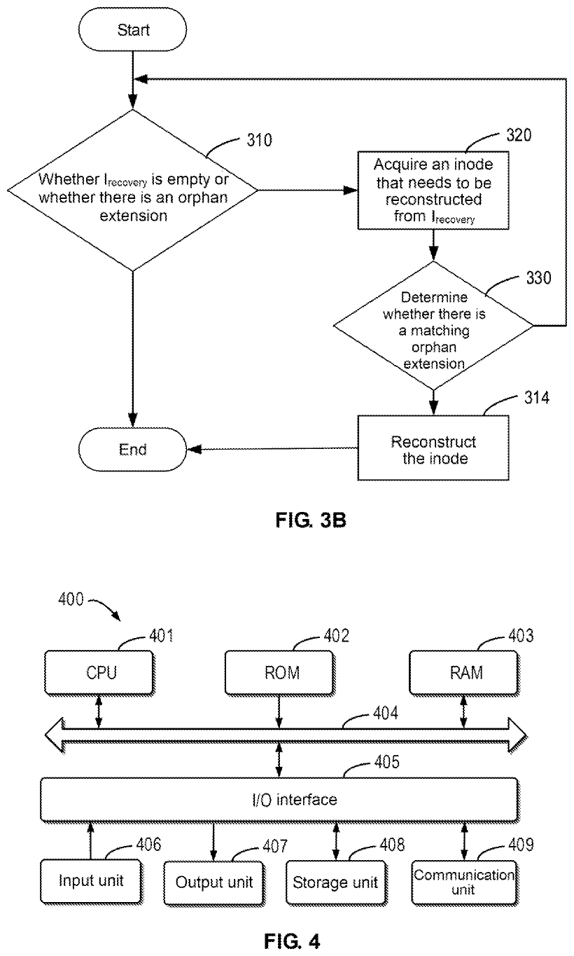

In some embodiments, some associated data in the associated data corresponding to the target inode may also be acquired through the associated inode corresponding to the target inode. The associated inode corresponding to the target inode may be determined based on the snapshot group ID shown in Table 1. For example, when inodes 1, 2, and 17 shown in Table 1 have the same snapshot group ID, it may be determined that inodes 1 and 2 are associated inodes of inode 17. In addition, when a field used for indicating a data source in associated inode 1 points to inode 17, it means that associated inode 1 may be a snapshot or clone of inode 17, then it may further be determined that inode 1 is a family inode of inode 17. The missing inode, the associated inode, and the family inode may be further illustrated by FIG. 3A. Data provided by the family inode is more conducive to accurately recovering the missing inode. The associated data that can be acquired by the associated inode may include at least one of the following: a family ID, a parent inode ID, a tenant ID, or a globally unique file storage ID.

In some embodiments, some associated data in the associated data corresponding to the target inode may also be acquired from a storage control system (for example, host 110). The associated data acquired from the storage control system includes at least one of the following: the number of links to the target inode; or a timestamp used for creating the object.

As mentioned above, the following associated data may be acquired for the missing inode and for recovering the inode.

| Field | Description | Information source |
|---|---|---|
| mObjectType | Object type (file, | Mapping layer extension table |
| | directory, and | |
| | the like) | |
| mSnapGroupId | Snapshot group ID | Mapping layer extension table |
| mVolumeId | Volume ID | Mapping layer extension table |
| mFamilyId | Family ID | Associated inode |
| mInodeId | Inode ID | Mapping layer extension table |
| mParentId | Parent inode ID | Associated inode |
| mInstanceId | Object instance ID | Mapping layer extension table |
| mLinkCount | The number of links | Control system |
| | to target inode | (when only an inode of a file |
| | | type is recovered, it is always |
| | | set to 0) |
| mTenantId | Tenant ID | Associated inode |
| mDataExtentInfo | Data extension | Mapping layer extension table |
| | information | |
| mCreateTime | Timestamp for | Control system |
| | creating object | (set a recovery time) |
| mFsid | Globally unique file | Associated inode |
| | storage ID | |

At block 230, the missing inode is recovered based on the associated data corresponding to the target inode. In one example, the recovery may be achieved by reconstructing the inode in the inode table. In another example, the successful recovery of the inode may be notified in the form of a report. For example, the recovered inodes may be set in a “lost+found” directory, and a user may remove them from the “lost+found” directory before accessing the volume.

In some cases, it may not be possible to use the above method to fully recover the entire inode table at one time. Because some information is missing, some operations need to be performed after the data read/write path is recovered. The information may be acquired from logs and traces, control path databases, and the like, which helps achieve comprehensive recovery of the inode table to recover the data read/write path.

By recovering the missing inode in the data read/write path by using the above method to avoid volume-level data loss, the data loss rate of a storage product may be reduced, and user satisfaction may be improved.

It should be understood that the description of the above method is merely illustrative. In some other embodiments of the present invention, the above method may also perform data block recovery before the inode table is validated. Then, information for recovering the inode is acquired by performing the inode table validation, inode allocator validation, extension allocator validation, and mapping layer extension validation. Optionally, the missing inode is reconstructed based on the information. Next, extension overlap detection, inode allocator reconstruction, and extension reconstruction may further be performed, a DL/DE (optional) may be set on the inode, space accounting fields recovery may be performed, named attr validation may be performed, directory validation and recovery may be performed, and a report for the recovered inode may be generated for use in subsequent data reading/writing.

FIG. 3B is a schematic flow chart of reconstructing a missing inode according to some embodiments of the present disclosure. First, in step 310, it is determined whether I_{recovery} is empty or whether there is an orphan extension. If the determination in step 310 is no, an inode that needs to be reconstructed is acquired from I_{recovery} (step 320). Next, in step 330, it is determined whether there is a matching orphan extension for the inode. If the determination in step 330 is no, the process proceeds to step 310. If the determination in step 330 is yes, the inode is reconstructed (step 340). If the determination in step 310 is yes, the reconstructing process ends.

FIG. 4 shows a schematic block diagram of example device 400 that may be used for implementing embodiments of the present disclosure. For example, the method for data recovery shown in FIG. 2 may be implemented by device 400. As shown in FIG. 4, device 400 includes central processing unit (CPU) 401 which may perform various appropriate actions and processing according to computer program instructions stored in read-only memory (ROM) 402 or computer program instructions loaded from storage unit 408 to random access memory (RAM) 403. RAM 403 may further store various programs and data required by operations of device 400. CPU 401, ROM 402, and RAM 403 are connected to each other through bus 404. Input/output (I/O) interface 405 is also connected to bus 404.

A plurality of components in device 400 are connected to I/O interface 405, including: input unit 406, such as a keyboard and a mouse; output unit 407, such as various types of displays and speakers; storage unit 408, such as a magnetic disk and an optical disc; and communication unit 409, such as a network card, a modem, or a wireless communication transceiver. Communication unit 409 allows device 400 to exchange information/data with other devices through a computer network such as the Internet and/or various telecommunication networks.

The various processes and processing described above, for example, method 200, may be executed by processing unit 401. For example, in some embodiments, method 200 may be implemented as a computer software program that is tangibly included in a machine-readable medium such as storage unit 408. In some embodiments, part of or all the computer program may be loaded and/or installed onto device 400 via ROM 402 and/or communication unit 409. When the computer program is loaded to RAM 403 and executed by CPU 401, one or more actions of method 200 described above may be implemented.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any appropriate combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described here with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means (e.g., specialized circuitry) for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The selection of terms used herein is intended to best explain the principles and practical applications of the various embodiments or the improvements to technologies on the market, or to enable other persons of ordinary skill in the art to understand the embodiments disclosed here.

1. A method for data recovery, comprising:
determining, based on a relationship between a missing inode in an inode table and a data logical address in an extension table, whether the inode is a target inode that is able to be recovered;
acquiring, in response to a determination that the inode is the target inode, associated data corresponding to the target inode; and
recovering the inode based on the acquired associated data.

2. The method according to claim 1, wherein determining whether the inode is a target inode comprises:
determining whether the inode is a failed inode by validating the inode in the inode table;
determining, by validating an inode allocator, a missing inode corresponding to the failed inode from an inode set indicated by the inode allocator; and
determining whether the failed inode is the target inode by using the missing inode and the extension table.

3. The method according to claim 2, wherein determining whether the failed inode is the target inode comprises:
determining, for the missing inode, whether there is an associated data logical address in the extension table; and
determining the failed inode as the target inode in response to a determination that the associated data logical address exists in the extension table.

4. The method according to claim 1, wherein acquiring the associated data comprises:
acquiring first associated sub-data associated with the target inode from a mapping layer, and
the first associated sub-data comprises at least one of the following: an object type, a snapshot group identity (ID), a volume ID, an inode ID, an object instance ID, or data extension information.

5. The method according to claim 4, wherein acquiring the associated data further comprises:
determining, based on the snapshot group ID, an associated inode corresponding to the target inode in the inode table; and
acquiring, by using the associated inode, second associated sub-data associated with the target inode.

6. The method according to claim 5, wherein acquiring the associated data further comprises:
determining whether the associated inode is a family inode based on a field used for indicating a data source in the associated inode, and
in a case where the associated inode is a family inode, the second associated sub-data is acquired through the family inode.

7. The method according to claim 6, wherein the second associated sub-data comprises at least one of the following: a family ID, a parent inode ID, a tenant ID, or a globally unique file storage ID.

8. The method according to claim 7, wherein acquiring the associated data further comprises:
acquiring, from a storage control system, third associated sub-data associated with the target inode,
wherein the third associated sub-data comprises at least one of the following: the number of links to the target inode, or a timestamp used for creating the object.

9. The method according to claim 1, wherein recovering the inode comprises: reconstructing the inode in the inode table.

10. An electronic device, comprising:
at least one processor; and
at least one memory storing computer program instructions, the at least one memory and the computer program instructions being configured together with the at least one processor to cause the electronic device to perform actions comprising:
determining, based on a relationship between a missing inode in an inode table and a data logical address in an extension table, whether the inode is a target inode that is able to be recovered;
acquiring, in response to a determination that the inode is the target inode, associated data corresponding to the target inode; and
recovering the inode based on the acquired associated data.

11. The electronic device according to claim 10, wherein determining whether the inode is a target inode comprises:
determining whether the inode is a failed inode by validating the inode in the inode table;
determining, by validating an inode allocator, a missing inode corresponding to the failed inode from an inode set indicated by the inode allocator; and
determining whether the failed inode is the target inode by using the missing inode and the extension table.

12. The electronic device according to claim 11, wherein determining whether the failed inode is the target inode comprises:
determining, for the missing inode, whether there is an associated data logical address in the extension table; and
determining the failed inode as the target inode in response to a determination that the associated data logical address exists in the extension table.

13. The electronic device according to claim 12, wherein acquiring the associated data comprises:
acquiring first associated sub-data associated with the target inode from the extension table, and
the first associated sub-data comprises at least one of the following: an object type, a snapshot group identity (ID), a volume ID, an inode ID, an object instance ID, or data extension information.

14. The electronic device according to claim 13, wherein acquiring the associated data further comprises:
determining, based on the snapshot group ID, an associated inode corresponding to the target inode in the inode table; and
acquiring, by using the associated inode, second associated sub-data associated with the target inode.

15. The electronic device according to claim 14, wherein acquiring the associated data further comprises: determining whether the associated inode is a family inode based on a field used for indicating a data source in the associated inode, and
in a case where the associated inode is a family inode, the second associated sub-data is acquired through the family inode.

16. The electronic device according to claim 14, wherein the second associated sub-data comprises at least one of the following: a family ID, a parent inode ID, a tenant ID, or a globally unique file storage ID.

17. The electronic device according to claim 16, wherein acquiring the associated data further comprises: acquiring, from a storage control system, third associated sub-data associated with the target inode,
wherein the third associated sub-data comprises at least one of the following: the number of links to the target inode, or a timestamp used for creating the object.

18. The electronic device according to claim 10, wherein recovering the inode comprises: reconstructing the inode in the inode table.

19. A computer program product tangibly stored on a non-volatile computer-readable medium and comprising machine-executable instructions, wherein the machine-executable instructions, when executed, cause a device to perform a method of:
determining, based on a relationship between a missing inode in an inode table and a data logical address in an extension table, whether the inode is a target inode that is able to be recovered;
acquiring, in response to a determination that the inode is the target inode, associated data corresponding to the target inode; and
recovering the inode based on the acquired associated data.

20. The computer program product according to claim 19, wherein acquiring the associated data comprises:
acquiring first associated sub-data associated with the target inode from the extension table, and
the first associated sub-data comprises at least one of the following: an object type, a snapshot group identity (ID), a volume ID, an inode ID, an object instance ID, or data extension information.
